(19) United States
(12) Patent Application Publication
(10) Pub. No.: US 2024/0274970 A1
(43) Pub. Date: Aug. 15, 2024

(54) DEGASSING UNIT FOR ELECTRONICS HOUSING AND ELECTRONICS HOUSING COMPRISING DEGASSING UNIT

(71) Applicant: MANN+HUMMEL GmbH, Ludwigsburg (DE)

(72) Inventor: Thomas SCHLEIDEN, Oberstenfeld (DE)

(21) Appl. No.: 18/641,415

(22) Filed: Apr. 21, 2024

Related U.S. Application Data
(63) Continuation of application No. PCT/EP2022/082152, filed on Nov. 16, 2022.

(30) Foreign Application Priority Data
Dec. 1, 2021 (DE) 102021131551.4

(51) Int. Cl. H01M 50/342; H01M 50/249; H01M 50/30

(52) U.S. Cl. CPC H01M 50/3425; H01M 50/394; H01M 50/249

(57) ABSTRACT

A degassing unit for an electronics housing includes a base body fluid-tightly connectable to an edge of a pressure compensation opening of the electronics housing, the base body comprising a gas passage opening, a membrane covering the gas passage opening and being fluid-tightly connected to the base body in a region surrounding the gas passage opening, an emergency degassing mandrel comprising a tip pointing towards the membrane, a contact element being resiliently displaceable and disposed between the tip of the emergency degassing mandrel and the membrane in a non-operating state, a covering hood disposed on an exterior side of the base body, and a spring element for a resilient bearing of the contact element, the spring element being interposed between the covering hood and the contact element.

### CROSS-REFERENCE TO RELATED APPLICATIONS

This application is a continuation application of International Application No. PCT/EP2022/082152 filed on Nov. 16, 2022, which claims the benefit of German Application No. 102021131551.4 filed on Dec. 1, 2021, the entire disclosures of which are incorporated herein by reference for all purposes.

### BACKGROUND

Embodiments relate to a degassing unit for an electronics housing, featuring a base body fluid-tightly connectable to an edge of a pressure compensation opening of the electronics housing, the base body featuring at least one gas passage opening covered by a membrane, wherein the membrane is fluid-tightly connected to the base body in a region surrounding the gas passage opening, and an emergency degassing mandrel having a tip pointing towards the membrane. The embodiments relate furthermore to an electronics housing having a degassing unit.

A degassing unit and an electronics housing of the above-mentioned type are known, for example, from DE 10 2011 080 325 A1.

Emergency venting of electrical equipment such as batteries is an important function to prevent the housing from bursting in the event of a pressure increase inside. Particularly in the case of high-voltage batteries such as those used as traction batteries in electric vehicles, battery cell failure can occur, leading to a sharp increase in pressure and temperature in the interior space of the housing. In order to prevent the housing from bursting, the hot and extremely pressurized gas must be quickly discharged from the interior space of the housing to the environment.

To prevent liquids or particles from the environment from entering the housing during normal operation, corresponding degassing units often have a membrane as a separation layer to the environment. The membrane should burst at a given pressure. Typically, some kind of mandrel is provided for bursting the membrane. This requires a deformation of the membrane due to the overpressure, so that the membrane contacts the mandrel at the desired burst pressure and bursts.

For example, the degassing unit known from the above-mentioned DE 10 2011 080 325 A1 features a plane membrane fixed to a base body. When reaching a critical deformation of the membrane, the membrane is damaged by a fixed emergency degassing mandrel such that the membrane releases the gas passage opening at least partially for emergency degassing of the housing.

For such planar or flat membranes, the burst pressure is substantially dependent on the material properties of the membrane and its size, as well as the distance between the membrane and the mandrel. Thus, for degassing units known from the background art, different materials for the membrane or different mandrel positions are required for different burst pressures. This may require the mandrel to be positioned very close to the membrane, and damage can occur under normal operating conditions (e.g., due to pressure fluctuations occurring in a battery during normal operation). Furthermore, the area of the membrane that can be realized in the installation space can prevent the implementation of low burst pressures. Finally, the tolerance for the emergency degassing pressure or bursting pressure depends on fluctuations in the material properties and is thus in most cases relatively large (often for example +/−50% of the nominal bursting pressure).

It is an object of the embodiments to provide a degassing unit which reliably opens at a precisely predefinable and preferably low emergency degassing pressure.

### SUMMARY

This object is solved by a degassing unit having the features specified in claim 1 as well as an electronics housing according to claim 16. Preferred embodiments are specified in the subclaims and the description.

According to the embodiments, a degassing unit for an electronics housing is provided. The electronics housing is preferably a battery housing, in particular for a traction battery of a motor vehicle. The electronics housing features a pressure compensation opening in a housing wall.

The degassing unit features a base body that is fluid-tightly connectable to an edge of the pressure compensation opening of the electronics housing. At least one gas passage opening is provided in the base body. Typically, several gas passage openings are provided in the base body. The gas passage openings can, for example, be separated from each other by webs or ribs. The gas passage opening is or the gas passage openings are covered by a membrane. The membrane is fluid-tightly connected to the base body in a region surrounding the gas passage opening or the gas passage openings. In particular, the membrane can prevent particles and liquid from penetrating the electronics housing through the pressure compensation opening or the gas passage opening(s).

Furthermore, the degassing unit features an emergency degassing mandrel. The emergency degassing mandrel is basically disposed on the exterior side of the membrane and extends towards the membrane. For describing the embodiments, indications such as inside or outside generally refer to the electronics housing or a condition of the degassing unit disposed on the electronics housing, unless otherwise indicated. A tip of the emergency degassing mandrel faces the membrane. In a non-operating state of the degassing unit, the tip can feature a predetermined distance from the membrane. In particular, the non-operating state describes the position of the membrane which occurs when the internal pressure in the electronics housing corresponds to a normal operating pressure, in particular when the internal pressure corresponds to an ambient pressure.

According to the embodiments, a resiliently displaceable contact element is disposed between the tip of the emergency degassing mandrel and the membrane in the non-operating state. In other words, the contact element protrudes beyond the tip of the emergency degassing mandrel towards the membrane. The contact element, which is in a non-operating state, thus prevents the membrane from being damaged by the emergency degassing mandrel. Before the membrane reaches the tip of the emergency degassing mandrel, it touches the contact element. The contact element can be positioned behind the tip of the emergency degassing mandrel against the spring action. In order to destroy the membrane for an emergency degassing process using the emergency degassing mandrel, the contact element has to be moved against the spring action up to or behind the tip of the emergency degassing mandrel. The emergency degassing pressure can thus be controlled by the spring stiffness. By varying the bearing stiffness of the contact element, the degassing unit can be adjusted to different emergency degassing pressures without modifying other components. In particular, the resiliently supported contact element reduces the influence of manufacturing tolerances of the membrane on the emergency degassing pressure. For example, an emergency degassing pressure deviating from the set value by a maximum of 10% can be achieved. In addition, the resilient contact element reduces the dependence of the emergency degassing pressure on the temperature by making the spring stiffness of the resilient bearing largely independent of the temperature. Aging influences are also reduced. Furthermore, the resilient contact element allows the use of membranes or membrane materials which could not previously be used for generic degassing units. Flexibility is increased and makes it possible to achieve cost benefits.

The membrane is displaceable against a force generated by the resiliently displaceable contact element. When the degassing unit on a battery housing is in an assembly condition, the membrane is displaced, in particular axially, when subjected to internal pressure. This displacement against the action of internal pressure is only possible by overcoming the force generated by the resiliently displaceable contact element. The degassing behavior of the degassing unit according to the embodiments—i.e. the determination of the internal pressure at which the emergency degassing mandrel causes the membrane to burst—is now possible in the degassing unit according to the embodiments simply and conveniently by designing the spring constant of the resiliently displaceable contact element. The membrane, which is subject to considerable manufacturing tolerances, only plays a subordinate role here, which contributes to a significantly more precisely adjustable degassing behavior.

The contact element can be spaced apart from the membrane in the non-operating state. Preferably, the contact element contacts the membrane in the non-operating state. The contact element can be biased against the membrane. This can reduce or prevent vibrations of the membrane. This can increase the service life and help to avoid damage to the membrane during normal operation.

When in the non-operating state, the membrane can extend in a plane. Preferably, the membrane features a bellows structure. In particular, the bellows structure can be designed concentrically to an axis of the emergency degassing mandrel. The bellows structure allows the membrane to deflect substantially without force or pressure. The influence of manufacturing tolerances on the emergency degassing pressure can thus be further reduced. In particular, it can be achieved that the emergency degassing pressure is substantially determined by the spring stiffness of the bearing of the contact element. As a result, particularly low emergency degassing pressures can be set up, in particular without increasing the size of the degassing unit. The bellows structure can be formed by a single or multiple corrugation or folding of the membrane. The bellows structure of the membrane can be obtained by a forming operation, in particular deep drawing or thermoforming. The term “bellows structure” is to be interpreted broadly and is not to be understood in such a restrictive manner that this “bellows” must result from a folding process or, for example like an accordion, has a one-dimensional extension. In the case of a bellows structure designed concentrically to the axis of the emergency degassing mandrel, the membrane has a bellows shape in section, in particular in longitudinal section, i.e. is corrugated one or more times in section. The term “bellows structure” also explicitly includes smaller, preferably annular-concentric elevations in the vertical direction, wherein the height of the elevations can be in the range from 0.3 to 5 mm, in particular 0.7 to 3 mm, in particular 0.8 to 5 mm.

The emergency degassing pressure, i.e. the overpressure of the interior space of the electronics housing relative to the environment at which the membrane is disrupted by the emergency degassing mandrel, can be at least 75 hPa, in particular at least 100 hPa, and/or at most 300 hPa, in particular at most 200 hPa.

A stroke of the membrane or of the contact element from the non-operating state until the membrane is destroyed, or the tip of the emergency degassing mandrel is exposed can be at least 1 mm, in particular at least 3 mm, in particular at least 3.5 mm, and/or at most 5 mm, in particular at most 4.5 mm.

In the non-operating state, the membrane can rest against a support device. This further reduces movements of the membrane during normal operation. In particular, it can be avoided that the membrane is bulged inwards. The support device can be arranged on the base body. In particular, the support device and the base body can be integrally formed with each other.

Preferably, the support device and the bellows structure are designed to correspond to each other. In this way, the membrane can rest flat against the support device in the non-operating state.

The degassing unit can feature a protective grid which overlaps the membrane on the interior side. If available, the protective grid preferably also overlaps a support device for the membrane on the interior side. Damage to the membrane during assembly of the degassing unit or due to loose parts inside the electronics housing can be avoided by the protective grid.

The protective grid and the base body can be held together by sleeves for allowing passage of fastening devices. The sleeves can, for example, engage in the base body in a latching manner and feature a collar for bearing against the protective grid. This simplifies the assembly of the degassing unit. The fastening devices for attaching the degassing unit to the electronics housing can be, for example, screws or rivets.

Preferably, the contact element features a recess for allowing passage of the emergency degassing mandrel. This allows the contact element to be arranged concentrically to the emergency degassing mandrel. The contact element can be annular or sleeve-shaped. A symmetrical design can further reduce the influence of manufacturing tolerances on the emergency degassing pressure.

A spring element for the resilient bearing of the contact element is preferably a helical spring, in particular a cylindrical helical spring. Helical springs are available at low cost with different spring stiffnesses.

Alternatively, the spring element for the resilient bearing of the contact element can be a leaf spring. The leaf spring can feature several, in particular curved, spring arms. When in the non-operating state, the leaf spring can extend in a plane. By using a leaf spring, a height of the degassing unit can be reduced.

The spring element and the contact element can be integral with each other or preferably separate components. In the latter case, the contact element can be latched to the spring element. A one-piece design of the spring element and the contact element can be considered in particular if the spring element is a flat or leaf spring, which can feature a contact surface formed as a contact element.

The spring element for the resilient bearing of the contact element can surround the emergency degassing mandrel. In particular, the spring element can be disposed concentrically to the emergency degassing mandrel. Preferably, the emergency degassing mandrel forms a guide for the spring element and/or the contact element. As a result, it can be achieved that the force required to release the tip of the emergency degassing mandrel and, consequently, the emergency degassing pressure are maintained particularly precisely.

The membrane can be gas-permeable but fluid-impermeable. In other words, the membrane can be semi-permeable. The membrane thus allows a slow gas exchange between the interior space and the environment of the electronics housing during normal operation. At the same time, the membrane prevents liquids and solids from entering the electronics housing. In particular, the semi-permeable membrane can completely prevent the ingress of water from the outside up to a defined water pressure, preferably up to a water pressure of at least 100, particularly preferably 250, very particularly preferably at least 3000 millimeters of water column. The semi-permeable membrane can feature an average pore size that can range from 0.01 micrometer to 20 micrometers. The porosity is preferably about 50%; the average pore size is preferably about 10 micrometers.

As an alternative, the membrane can be impermeable to fluids of all types, i.e. in particular gases and liquids.

The (in particular semi-permeable) membrane can be made of thermoplastic, for example polytetrafluoroethylene (PTFE). In particular, the membrane can be made of expanded or preferably sintered PTFE. As an alternative, the membrane can be made of (thermoplastic) polypropylene (PP).

The membrane thickness of the membrane is basically much smaller than its other external dimensions. The membrane can cover a minimum width and/or a minimum length or a minimum external diameter of at least 20 mm, preferably of at least 30 mm, in particular of at least 40 mm. The membrane thickness can be at least 20 times, preferably at least 40 times, in particular at least 100 times, smaller than the minimum width and/or the minimum length or the minimum external diameter of the membrane. The membrane thickness can preferably be at least 1 micrometer, preferably at least 10 micrometers, wherein the membrane can feature, in particular over its entire membrane surface, a substantially constant membrane thickness. The membrane thickness can be at most 1 mm, particularly preferably at most 0.5 mm.

A covering hood can be disposed on the exterior side of the base body. The covering hood can prevent damage to the membrane from outside during operation of an electronics housing with the degassing unit. Between the covering hood and the base body, a flow path leading through the at least one gas passage opening basically remains open between the environment and the interior space.

Advantageously, the covering hood is latched to the base body. This simplifies the assembly of the degassing unit.

Preferably, the emergency degassing mandrel and the covering hood are integrally formed with each other. This allows cost-effective production and further simplifies assembly.

As an alternative, the emergency degassing mandrel can be attached to the base body. In particular, the emergency degassing mandrel and the base body can be integrally formed with each other.

The spring element for the resilient bearing of the contact element can rest against the covering hood or the base body. The former simplifies assembly. As for the latter, the base body can feature a support arm. This makes it possible to eliminate the need for a covering hood.

A sealing element for sealing against the electronics housing can be disposed on the base body. The sealing element can be designed as axial seal or as radial seal, i.e. in particular on a front face (in the case of the axial seal) or on a circumferential surface (in the case of the radial seal). For a radial seal, the base body can feature a connecting piece for engaging in the pressure compensation opening. An axial seal can engage in a groove of the base body.

Also within the scope of the embodiments is an electronics housing, in particular a battery housing, having a degassing unit as described above in accordance with the embodiments. The degassing unit is basically disposed at a pressure compensation opening of the electronics housing. The advantages of the degassing unit become apparent also and especially when using the electronics housing.

Further within the scope of the embodiments is a battery, in particular a traction battery for a motor vehicle, which features an electronics housing or battery housing as described above in accordance with the embodiments and battery cells disposed in the battery housing. Here, the advantageous effects of the degassing unit are particularly apparent. The battery cells can be, for example, lithium ion cells.

### BRIEF DESCRIPTION OF DRAWINGS

Other features and advantages of the embodiments will become apparent from the following detailed description of embodiment examples, from the patent claims as well as with reference to the figures of the drawing which show details according to the embodiments. The aforementioned features and those described in still further detail can be implemented individually or in any number of appropriate combinations in variants of the embodiments. The features shown in the drawing are presented in such a way that the special features according to the embodiments can be made clearly visible.

FIG. 1 is a degassing unit according to the embodiments, with a bellows-shaped corrugated membrane biased by a contact element against a support device, in a schematic sectional view.

FIG. 2 is the degassing unit of FIG. 1 in a cut, schematic perspective view.

FIG. 3 is a schematic exploded view of the degassing unit of FIG. 1.

FIG. 4 is a schematic top view of a side of the degassing unit of FIG. 1 facing an electronics housing, showing a protective grid for the membrane.

FIG. 5 is the degassing unit of FIG. 1 in a schematic perspective view looking at a covering hood on the exterior side.

FIG. 6 is an abstract representation of a battery with an electronics housing according to the embodiments, which features a degassing unit according to the embodiments.

### DETAILED DESCRIPTION

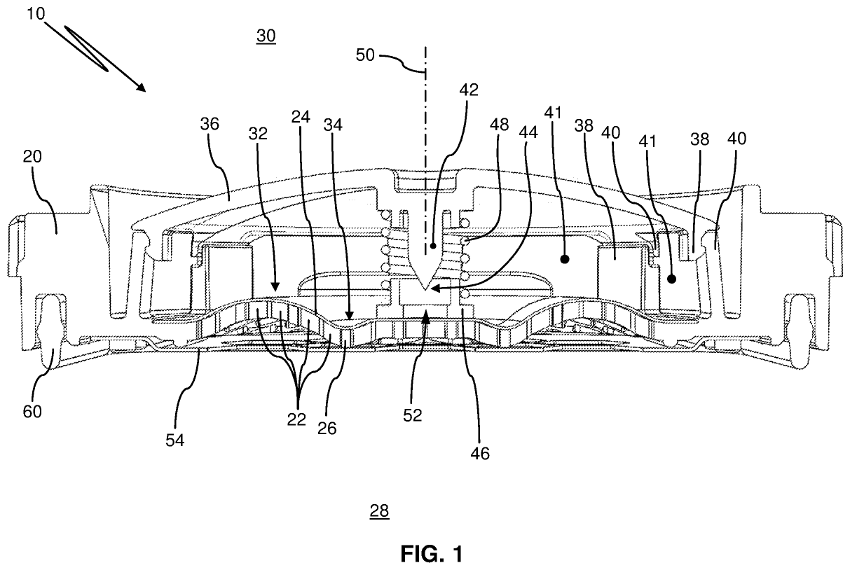

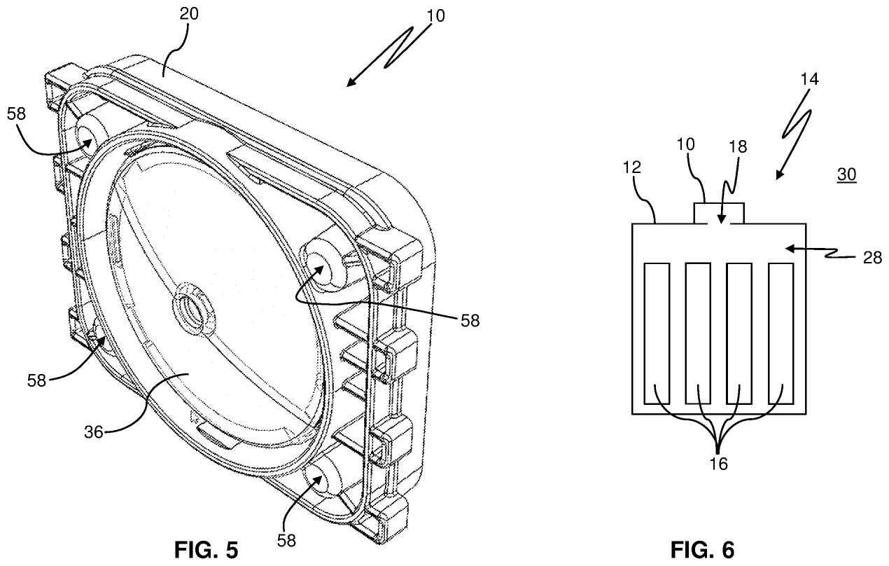

FIGS. 1 to 5 show a degassing unit 10 for an electronics housing 12 shown in FIG. 6 in various views. In the present case, the electronics housing 12 is a battery housing for a battery 14. A plurality of battery cells 16, for example lithium ion cells, are disposed in the electronics housing 12 or battery housing. The degassing unit 10 is disposed at a pressure compensation opening 18 in a housing wall of the electronics housing 12.

The degassing unit 10 features a base body 20. In the present case, a plurality of gas passage openings 22 are formed in the base body 20. The gas passage openings 22 are covered by a membrane 24. The membrane 24 is fluid-tightly connected to the base body 20 at its outer periphery, for example glued or welded thereto. The membrane 24 can be semi-permeable, i.e. gas-permeable but fluid-impermeable, and can be made of PTFE, for example.

The gas passage openings 22 are provided here in a support device 26 for the membrane 24. The support device 26 and the base body 20 can be integral with each other and formed, for example, by a common plastic injection molded part.

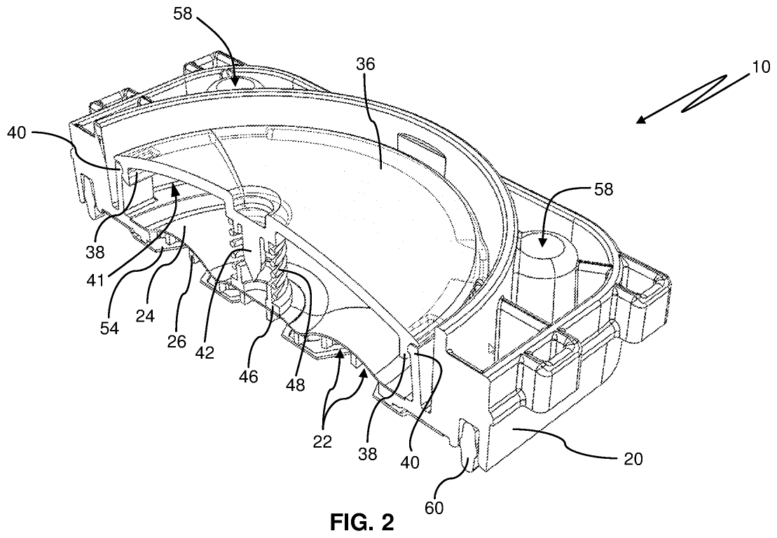

In particular, in FIGS. 1 and 2, the degassing unit 10 is in a non-operating state which occurs when an internal pressure in an interior space 28 of the electronics housing 12 corresponds to an ambient pressure in an environment 30 of the electronics housing 12. In the non-operating state, the membrane 24 rests against the support device 26. Because of the support device 26, the non-operating state also occurs when the ambient pressure is greater than the internal pressure.

In this case, the membrane 24 is bellows-shaped and features corrugations concentric to each other in the shape of projections 32 or recesses 34. This bellows structure of the membrane 24 can be obtained by a deep drawing process or thermoforming. The bellows structure softens the membrane 24, i.e., a central portion can be moved to a certain extent almost without force with respect to the fixed edge of the membrane 24. The support device 26 is shaped to correspond to the membrane 24. This allows the membrane 24 to contact the support device 26 in a substantially planar manner.

On the exterior side of the embodiment shown, a covering hood 36 is disposed on the base body 20. The covering hood 36 and the base body 20 can be latched to one another by latching elements 38, 40. Flow windows 41 remain open between covering hood 36 and base body 20.

The degassing unit 10 features an emergency degassing mandrel 42. A tip 44 of the emergency degassing mandrel 42 is pointed towards the membrane 24. When viewed from the interior space 28 of the electronics housing 12, the emergency degassing mandrel 42 is located on the exterior side of the membrane 24. In the embodiment shown in FIGS. 1 to 5, the emergency degassing mandrel 42 is integrally formed with the covering hood 36.

The degassing unit 10 further features a contact element 46. The contact element 46 is resiliently supported by a spring element 48. In other words, the contact element 46 is displaceable against the action of the spring force of the spring element 48. In the illustrated embodiment, the spring element 48 is a coil spring. On the one hand, the spring element 48 rests against the contact element 46. On the other hand, the spring element 48 can rest against the covering hood 36.

The contact element 46 is biased towards the membrane 24 or the support device 26 by the spring element 48. In the non-operating state, at least one end of the contact element 46 facing the membrane 24 is disposed between the tip 44 of the emergency degassing mandrel 42 and the membrane 24. In other words, in the non-operating state, the end of the contact element 46 facing the membrane 24 is disposed closer to the support device 26 or the interior space 28 than the tip 44 of the emergency degassing mandrel 42. In the present case, the contact element 46 rests against the membrane 24 in the non-operating state and presses it against the support device 26.

In this case, the contact element 46 and the spring element 48 are disposed concentrically with respect to an axis 50 of the emergency degassing mandrel 42. In particular, the spring element 48 and the contact element 46 circumferentially surround the axis 50. The corrugations of the bellows structure of the membrane 24 also extend concentrically with respect to the axis 50.

When the internal pressure in the interior space 28 of the electronics housing 12 rapidly rises above the ambient pressure in the environment 30, the membrane 24 is lifted off the support device 26. The contact element 46 is now entrained by the membrane 24 and moved towards the covering hood 36 against the action of the spring element 48.

The contact element 46 features a recess 52 for allowing passage in particular of the tip 44 of the emergency degassing mandrel 42. When the membrane 24 and the contact element 46 are deflected, its recess 52 is slid over the emergency degassing mandrel 42. In this case, the contact element 46 can be guided on the emergency degassing mandrel 42.

When the overpressure in the interior space reaches a predetermined emergency degassing pressure, the tip 44 of the emergency degassing mandrel 42 hits the membrane 24, causing it to be destroyed. The pressurized gas from the interior space 28 can therefore quickly escape through the gas passage openings 22 and the flow windows 41 into the environment 30. Bursting of the electronics housing 12 is thus avoided.

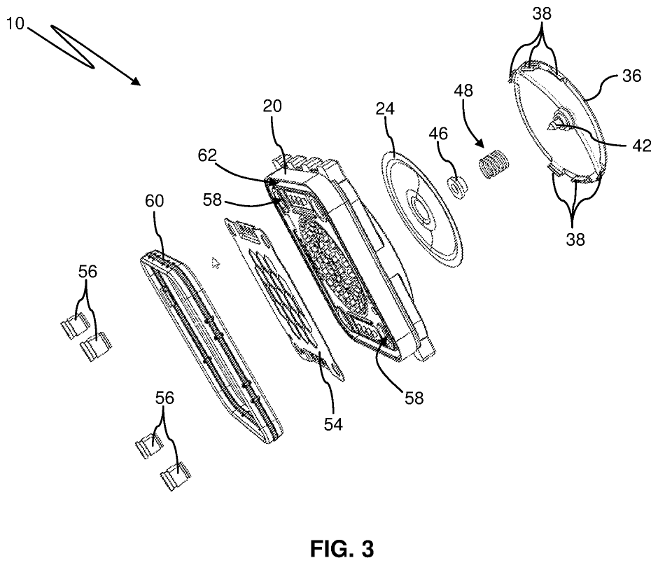

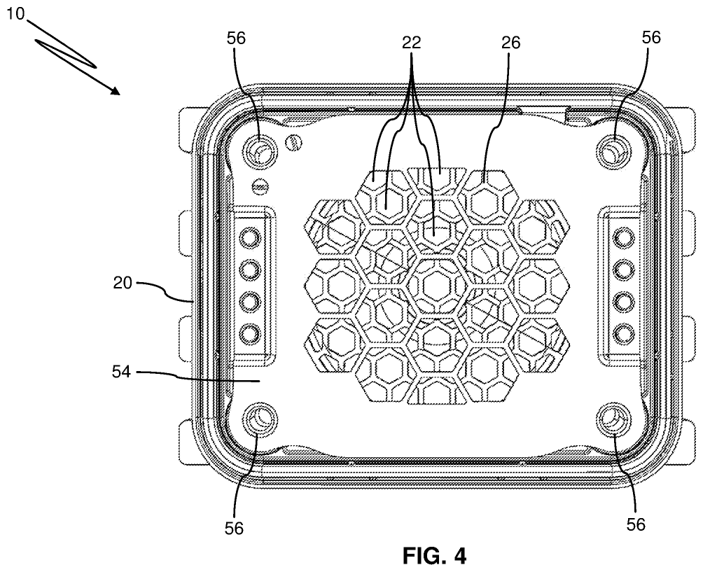

In the embodiment shown, the degassing unit 10 features a protective grid 54, cf. in particular FIGS. 3 and 4. The protective grid 54 is disposed on the interior side of the membrane 24 and of the support device 26. In other words, the protective grid 54 is located beyond the membrane 24 and the support device 26 as seen from the emergency degassing mandrel 42. The protective grid 54 covers the membrane 24 and the support device 26 to the interior space 28 of the electronics housing 12.

The protective grid 54 can be held to the base body 20 by sleeves 56. In particular, the sleeves 56 can rest on the protective grid 54 and latched or pressed into the base body 20. The base body 20 can feature fastening recesses 58 (cf. in particular FIGS. 2, 3 and 5) into which the sleeves 56 engage. Fastening devices, for example such as screws, for fastening the degassing unit 10 to the electronics housing 12 can engage through the fastening recesses 58 or the sleeves 56 (not shown in more detail).

For sealing the base body 20 from the electronics housing 12, the degassing unit 10 features a sealing element 60. The sealing element 60 can engage in a groove 62 of the base body 20. In the present case, the sealing element 60 is an axial seal.

1. A degassing unit for an electronics housing, the degassing unit comprising:
a base body fluid-tightly connectable to an edge of a pressure compensation opening of the electronics housing, the base body comprising a gas passage opening;
a membrane covering the gas passage opening and being fluid-tightly connected to the base body in a region surrounding the gas passage opening;
an emergency degassing mandrel comprising a tip pointing towards the membrane;
a contact element being resiliently displaceable and disposed between the tip of the emergency degassing mandrel and the membrane in a non-operating state;
a covering hood disposed on an exterior side of the base body; and
a spring element for a resilient bearing of the contact element, the spring element being interposed between the covering hood and the contact element.

2. The degassing unit according to claim 1, wherein the membrane is displaceable against a force generated by the contact element.

3. The degassing unit according to claim 1, wherein the contact element rests on the membrane in the non-operating state.

4. The degassing unit according to claim 1, wherein the membrane has a bellows structure concentrically to an axis of the emergency degassing mandrel.

5. The degassing unit according to claim 4, further comprising a support device on which the membrane rests in the non-operating state.

6. The degassing unit according to claim 5, wherein the support device and the bellows structure are designed to correspond to each other.

7. The degassing unit according to claim 1, further comprising a protective grid overlapping the membrane on an interior side.

8. The degassing unit according to claim 7, further comprising sleeves for allowing passage of fastening devices for holding together the protective grid and the base body.

9. The degassing unit according to claim 1, wherein the contact element comprises a recess for allowing passage of the emergency degassing mandrel.

10. The degassing unit according to claim 1, wherein the spring element comprises a coil spring or a leaf spring.

11. The degassing unit according to claim 1, wherein the spring element surrounds the emergency degassing mandrel representing a guide for the spring element and/or the contact element.

12. The degassing unit according to claim 1, wherein the membrane is gas-permeable, however fluid-impermeable.

13. The degassing unit according to claim 1, wherein the covering hood is latched to the base body.

14. The degassing unit according to claim 13, wherein the emergency degassing mandrel and the covering hood are formed integrally with one another.

15. The degassing unit according to claim 1, further comprising a sealing element disposed on the base body and for sealing with respect to the electronics housing.

16. An electronics housing comprising:
a pressure compensation opening; and
a degassing unit comprising:
a base body fluid-tightly connectable to an edge of the pressure compensation opening, the base body comprising a gas passage opening;
a membrane covering the gas passage opening and being fluid-tightly connected to the base body in a region surrounding the gas passage opening;
an emergency degassing mandrel comprising a tip pointing towards the membrane;
a contact element being resiliently displaceable and disposed between the tip of the emergency degassing mandrel and the membrane in a non-operating state;
a covering hood disposed on an exterior side of the base body; and
a spring element for a resilient bearing of the contact element, the spring element being interposed between the covering hood and the contact element.
